(19) United States
(12) Patent Application Publication
(10) Pub. No.: US 2008/0071481 A1
(43) Pub. Date: Mar. 20, 2008

(54) Motion tracking apparatus and technique

(76) Inventor: Cherif Atia Algreatly, Newark, CA (US)

Correspondence Address: CHERIF ATIA ALGREATLY;MATHEMATICAL INVENTING - SILICON VALLEY, SUITE 286, 39962 CEDAR BLVD, NEWARK, CA, 94560, US

(21) Appl. No.: 11/900,986

(22) Filed: Sep. 14, 2007

Related U.S. Application Data
(63) Continuation-in-part of application No. PCT/EG2006/000030, filed on Aug. 14, 2006.

(51) Int. Cl. G01B 5/30; G01B 5/28

(52) U.S. Cl. 702/35

(57) ABSTRACT

An apparatus to be attached to a user's hand to detect its movement and functions as a multiple computer input device replicating the output of real computer input devices such as the keyboard, mouse, touch-pad, pointing stick, or digital template. The apparatus can be attached to a human body, animal body, building, or machine to detect the movement of such objects. Said apparatus is comprised of a plurality of sensing joints where each one of said sensing joints is attached to each individual joint of an object to emulate and detect its movement providing data to a computer system representing the rotation of that object's joint.

### CROSS-REFERENCE TO RELATED APPLICATION

This application is a Continuation-in-Part of co-pending International Application No. PCT/EG2006/000030, filed Aug. 14, 2006.

### BACKGROUND

Until now there is no distinct, universal technique used to track the motion of different living creatures such as a human body and animal body, or different inanimate objects such as buildings or machines. Although there are three main techniques that are currently used to track human body motion but each has its disadvantages.

The first technique is an optical system that utilizes cameras to track human motions using markers that are placed on different joints of the human's body; accordingly, it requires expensive hardware and extensive post processing, and cannot capture motion when markers are occluded for a long period of time. Furthermore, motion capture must be carried out in a controlled environment away from yellow light and reflective noise.

The second technique utilizes magnetic trackers using magnetic sensors for the tracking. Its drawbacks include innate sensitivity to metals that can cause irregular outputs, and performers in this environment are inherently constrained by cables in most cases and the capture area is usually small.

The third technique involves electromechanical body suits which tend to have low sample rates and its environment inherently applies constraints on human joints besides its obtrusiveness due to the sheer amount of hardware.

The present invention overcomes all the previous noted disadvantages of the three aforementioned techniques in addition to providing the ability to track the motion of several living creatures and inanimate objects. Overall, this invention serves different fields such as computers, building, medical/health care, movie production, sports, avionics, and biomechanics among others.

### SUMMARY

The present invention introduces a sensing joint that is able to detect its rotation in three dimensions. It can be placed on any joint of an object such as a human, animal, building, or machine body to emulate and detect the rotation of this object's joint. A plurality of said sensing joints can be attached to each others to simulate the composition of a group of object's joints to emulate the movement of this group and provides data to the computer system representing the movement of this group of joints or this object.

For example when the present invention is used for a human body to simulate the joints composition of one hand, in this case the user can utilize the present invention to provide data to a computer system representing the movement of his/her hand fingers. The case is similar when the present invention is used for the user's arm, leg, or complete body.

Based on this possibility the present invention introduces innovative tools that change the computer input methods, the existing buildings studies, the medical/health care monitoring, the 3D movie production techniques, and the sports training and analysis.

For example, the present invention changes the computer input devices into virtual invisible tools. This includes different keyboards, mice, touch-pads, pointing sticks, and digital templates. In these cases the user of the present invention will move his/her hands like s/he would hold the real computer input device; where the detection of the hand fingers movement provides immediate input to the computer system, replicating the output of the real computer input device.

Also the present invention facilitates the communication between the computer system and several everyday human tools without additional connections. For example, it is possible for the user of the present invention to employ a regular pen as a computer pen input device. The user can write on a regular piece of paper using the regular pen while the present invention simultaneously detects the user's hand/finger motions and provides immediate text input to the computer system.

The present invention converts the use of the regular computer display into a touch screen where the user can move his/her finger to point at any specific icon or menu on the computer display making the regular computer display react as a touch screen. That is done by detecting the user's hand/finger movements relative to the computer display's position and dimensions to manipulate the icons or menus to interact with the movement of the user's hand/finger.

The present invention enables the user to move any object in 3D on the computer display by moving the user's hand/finger in specific 3D directions in front of the computer to manipulate the object to move in the same 3D directions on the computer display. In other words, the present invention can have the functionality of a 3D mouse in very intuitive manner.

The present invention can also provide the details of the outlines of any 3D object to the computer system. This is achieved by making the user of the present invention touch the outlines of the 3D object with his/her finger, while the present invention provides immediate input for the positions of all the touched points of the 3D object to the computer system to simulate the details of the outlines of this object on the computer display.

In the existing buildings studies; the present invention provides a unique tool and technique to detect the motion of different building elements such as beams, columns, slabs, walls, or floors. Such detection gives valuable information for the building structure in different circumstance such as earthquakes, fire, wear, or even during attempts at thefts from break-ins; this application is important in saving the building occupants' lives from any sudden collapse, unexpected damage, or breach.

In the medical and health care monitoring; using the present invention enables and facilitates observation of patients' motions or their body shape changes. It is also possible to digitally record all the user's daily details of different activities such as walking, jogging, or sitting for the purpose of analysis and statistic record. All such data can be gathered in a memory chip and be connected to the computer or uploaded to the Internet where the doctor can observe the daily collected data or its simulation and give his/her advice to the patient.

Moreover, the present invention can provide a warning tool to alert the patient or the user when s/he moves his/her body in an awkward position during different activities such as sleeping, working out, or lifting a heavy object that might injure his/her back or others body parts.

In the 3D movie production techniques, the present invention gives a comprehensive yet inexpensive tool for the CG-animation or the 3D cartoon movies, wherein it is easy to capture the different motions of the performers to emulate or copy these motions into a movement for 3D cartoon characters.

In the sports training and analysis; the present invention is a perfect tool to be utilized in many applications to provide the computer system with data simulating the details of the user's body movements while practicing different sports, such as shooting a basketball into a net, shooting a ball in a soccer game, or swimming. The user can view the simulation of all such details on the computer display to recognize his/her mistakes. Also collecting the data of the players' motions using the present invention facilitates the analysis of the entire game to locate the team's/individual's mistakes during the competition.

The present invention also facilitates remote interactive virtual sporting, where two or more players can participate and compete in playing games remotely, whereas detecting each player's motions provide immediate input to the computer that can be connected to the Internet to transfer the action of the player to the others in different locations. This facilitates the involvement of several participants from different geographical location with the user in different times of the day.

### BRIEF DESCRIPTION OF THE DRAWINGS

FIG. 1 is a spherical sensing joint that emulates and detects the rotation of an object's spherical joint.

FIG. 2 is a diagrammatic illustration that represents a plurality of spherical sensing joints attached to each other to simulate the composition of the human's body main joints.

FIG. 3 is a diagrammatic illustration representing 15 spherical sensing joints attached to each other to simulate the composition of the joints of a human's right hand.

FIG. 4 is telescopic sticks comprised of a number of interconnected cylindrical members that protract and retract telescopically to change the total span of said telescopic sticks.

FIG. 5 is an illustration for two linear compositions of the spherical sensing joints attached to the top and bottom of a structural beam using the telescopic sticks whereas a concentrated load is on the top side of the structural beam.

FIG. 6 is three successive computer simulations for the structural beam in different times under different values of the concentrated load.

FIG. 7 is a 2D diagrammatic grid for a composition of a plurality of spherical sensing joints and telescopic sticks that are attached to each others.

FIG. 8 is another 2D diagrammatic grid for a composition of a plurality of spherical sensing joints and telescopic sticks that are attached to each other.

FIG. 9 is a 3D diagrammatic grid of a plurality of spherical sensing joints and telescopic sticks that are attached to each other in three dimensions.

FIG. 10 is a table that presents the ID's of 31 keys of a dotted sensor both in Arabic and binary numerals.

FIG. 11 is an illustration for a linear sensing joint that detects the linear movement of an object both forward and backward.

FIG. 12 is an illustration for a circular sensing joint that detects a two-dimensional rotation of an object.

FIG. 13 is an illustration for two circular sensing joints that are attached to each other to detect a three-dimensional rotation of an object.

### DETAILED DESCRIPTION

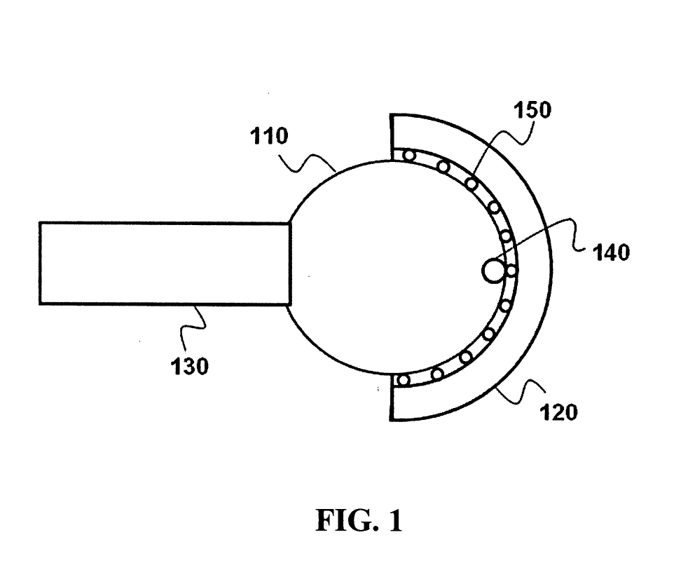

The present invention introduces an innovative, electromechanical sensing joint that can be in different shapes and is able to detect its rotation in three dimensions. FIG. 1 illustrates one shape of said sensing joint which is the spherical sensing joint that is comprised of; a rotating ball 110, a socket 120, a stick 130, a sensing point 140 and a spherical dotted sensor 150.

The rotating ball 110 is a sphere that rotates inside the socket according to the movement of the stick, the socket 120 serves as a container that houses the rotating ball, the stick 130 is the rotation controller of the rotating ball whereas its movement rotates the rotating ball inside the socket, the sensing point 140 is a small spot on the outer surface of the rotating ball, and the spherical dotted sensor 150 is the detector of the sensing point's position during its rotations which represents the rotational orientation of the rotating ball.

The position of any point on the outer surface of the rotating ball 120 can be represented by a tuple of three components (ρ, θ, and φ) of a spherical coordinate system wherein the center of the rotating ball is considered to be the origin of the spherical coordinate system, (ρ) is the distance between the point and the origin, (θ) is the angle between the positive x-axis and the line from the origin to the point projected onto the xy-plane, and (φ) is the angle between the z-axis and the line from the origin to the point.

The default position of the spherical sensing joint is assumed to be when the central axis of the stick, the center of the rotating ball, and the central axis of the socket aligned on one line as illustrated in FIG. 1; in this default position the spherical coordinate components of the sensing point are (ρ, 0, and 0).

When the stick is moved in three dimensions, the rotating ball is rotated and the sensing point is moved to change its position. Comparing the spherical coordinate components of the sensing point before and after each rotation gives information about the rotation of the rotating ball.

For example, if the sensing point is in the default position (ρ, 0, and 0) and is then moved to another position such as (ρ, 45, 30), that means the sensing point—and also the rotating ball—is rotated 45 degrees horizontally (in the x-y plane) and 30 degrees vertically (relative to the z-axis). If the sensing point is moved to another position (ρ, −25, 90), that means the sensing point—and also the rotating ball—is rotated −70 degrees horizontally (in the x-y plane) and 60 degrees vertically (relative to the z-axis). These movements appear where it is simple to specify the rotational value of the rotating ball by subtracting the starting and ending positions of the two components (θ) and (φ) of the sensing point.

The spherical dotted sensor 150 is a thin sheet covering the inner surface of the socket and contains a plurality of dots which are spread evenly on the sheet. Each dot has a unique ID number and each ID number has a defined position relative to the center of the rotating ball. When the sensing point 140 touches a specific dot, the ID of this specific dot is detected and, accordingly, the rotation of the sensing point is recognized which represents the rotational value of the rotating ball. During the rotation of the rotating ball, the sensing point touches different dots, thus the ID's of these different dots are detected which represent the different rotations of the rotating ball.

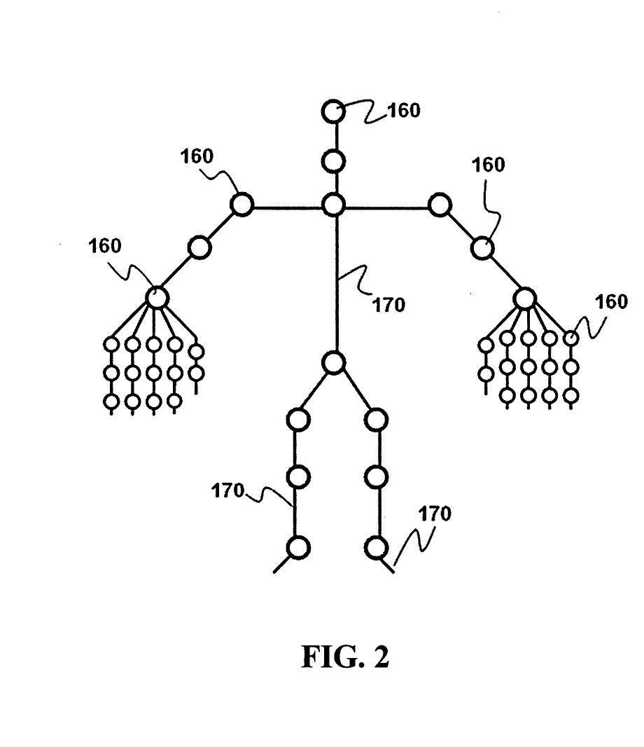

A plurality of said spherical sensing joints can be attached to each other, with any chosen one's stick attached to the bottom of another one's socket, and repeated as necessary. An example of such a composition can be seen in FIG. 2 which presents a diagrammatic illustration for 44 spherical sensing joints attached to each others in this manner to simulate the composition of the main joints of the human body.

In this figure the different spherical sensing joints 160 are attached to each other by the sticks 170. Although not all the joints of the human body are spherical in nature, but the functionality of the spherical joint covers all their possible rotations. The composition of FIG. 2 can be placed on a human body to detect the movement of its joints or the general motion of the body.

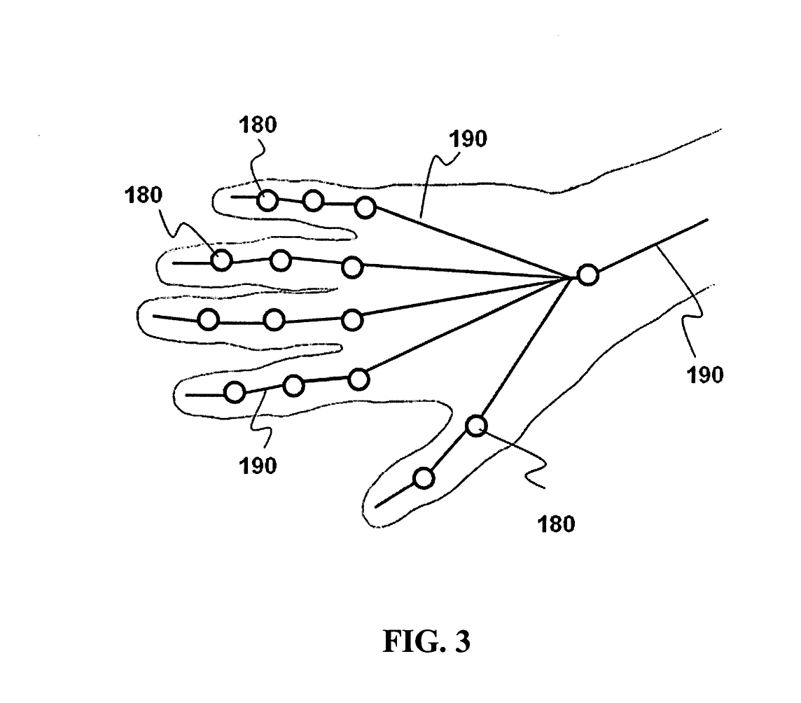

A part of the composition of FIG. 2 can be placed on a corresponding part of the human body to detect its movement, for example; FIG. 3 illustrates 15 spherical sensing joints 180 that are attached to each other by the sticks 190 and placed on the top side of a user's right hand. The placing is done by using double-faced tape which attaches the sockets of the spherical sensing joints to the user's right hand, positioning each rotating ball on top of one corresponding joint of the user's right hand. When the user moves the joints of his/her right hand, a group of said spherical sensing joints rotate to emulate and detect the rotation of each corresponding joint of the human's right hand.

The previous described technique of using the spherical sensing joints to detect the rotation of the joints of human body can serve many innovative applications. For example if the user of the present invention types on a computer keyboard, then all different finger rotations that led to the typing will be detected by the present invention. Such typing detection enables the user to type virtually, wherein the user can replicate the exact movements of fingers when typing without having a real keyboard where the detection of the finger's moves provides immediate input of the typing to the computer system.

The present technique of detecting the rotation of the joints can be employed in other innovative applications that depend on moving different human body parts such as arms, legs, head, or the entire body. In general, many fields can benefit from the present technique such as the computers, building, medical and healthcare, movie production, and sports as mentioned previously.

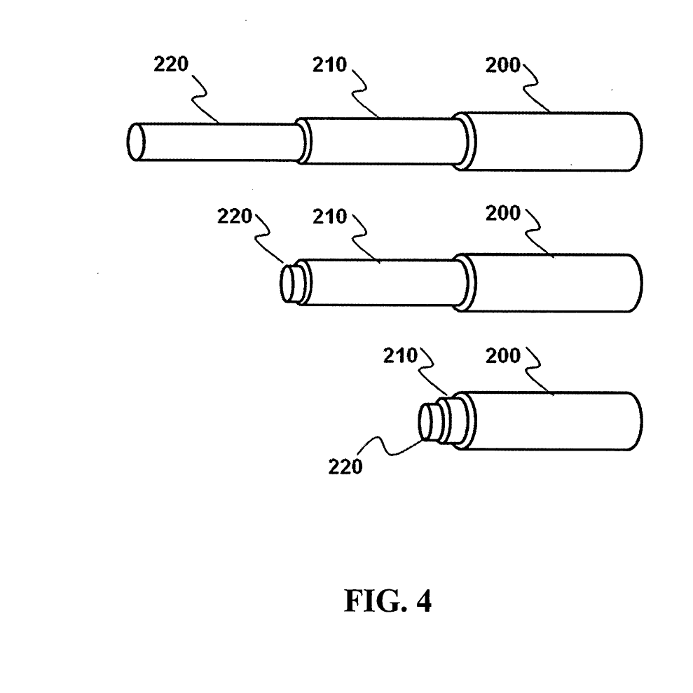

Attaching a plurality of the spherical sensing joints to each other as previously described allows different rotations for all rotating balls but doesn't allow any protraction or retraction for the stick of the spherical sensing joint. To remedy this; FIG.4 illustrates telescopic sticks that are comprised of a plurality of interconnected cylindrical members that slide inside each other telescopically to change the total span of the telescopic sticks.

In this figure as example the telescopic sticks are comprised of a base cylindrical member 200, intermediate cylindrical member 210, and a leading cylindrical member 220. Said telescopic sticks allow each pair of the spherical sensing joints to get nearer or further from each other when they are moved. The final span of said telescopic sticks after each protraction or retraction is detected by using a linear dotted sensor fixed inside each interconnected cylindrical member as will be described subsequently.

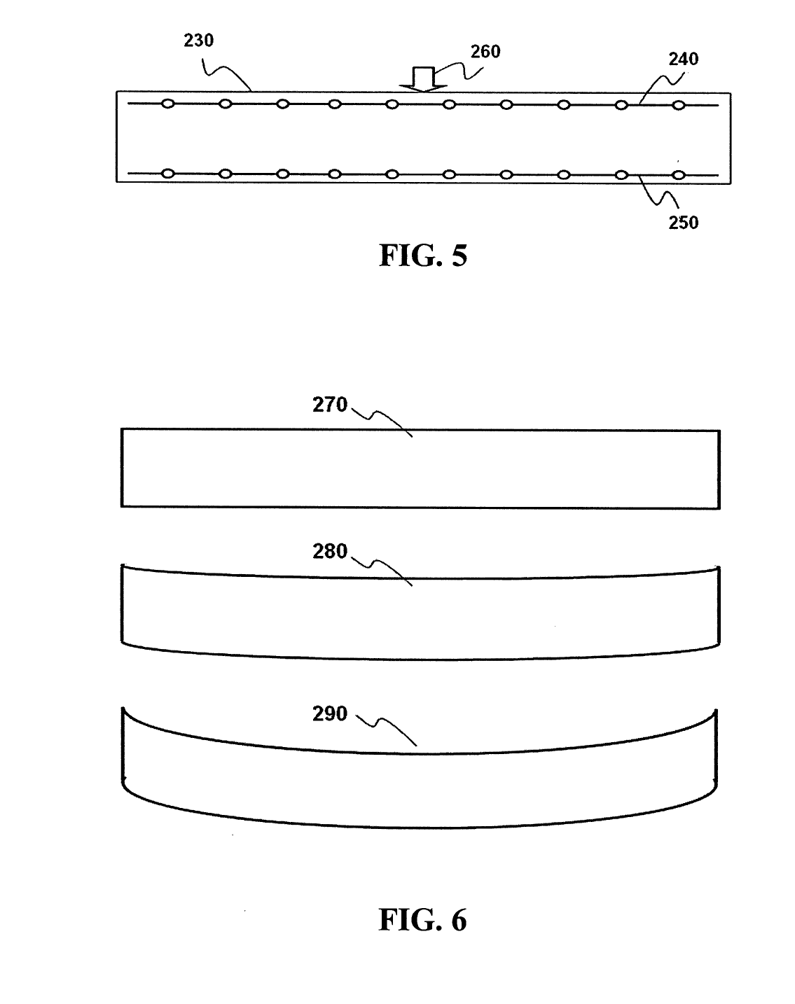

Assembling a plurality of said spherical sensing joints and said telescopic sticks in a linear arrangement enables us to obtain a linear motion tracking system which serves many applications. For example, FIG. 5 illustrates a structural beam 230, a linear arrangement 240 of spherical sensing joints and telescopic sticks attached to the top of the structural beam, another linear arrangement 250 of spherical sensing joints and telescopic sticks attached to the bottom of the structural beam, and a concentrated load on the top of the structural beam where this load is increased gradually. According to the load increasing over time the shape of this structural beam is changing causing some rotating balls of the spherical sensing joints to rotate, and some telescopic sticks to protract or retract.

In such cases the spherical dotted sensors of the spherical sensing joints and the linear dotted sensors of the telescopic sticks generate signals representing the rotation of the rotating balls of the spherical joints and the movements of the interconnected cylindrical members of the telescopic sticks. A microprocessor receives these signals and converts them into an input that can be provided to a computer system to simulate the change of the structural beam shape on the computer display.

FIG. 6 illustrates three successive figures for the structural beam simulation in different times under different concentrated loads. The first simulation 270 is when there is no change of the structural beam's shape. The second simulation 280 is when the concentrated load is increased, and the third simulation is when the concentrated load is highly increased. It is obvious that such an application is critical in affording the ability to record, simulate, or analyze the behavior of the building structures in different circumstances as in earthquakes, fires, or even aging to save the lives of the building's occupants.

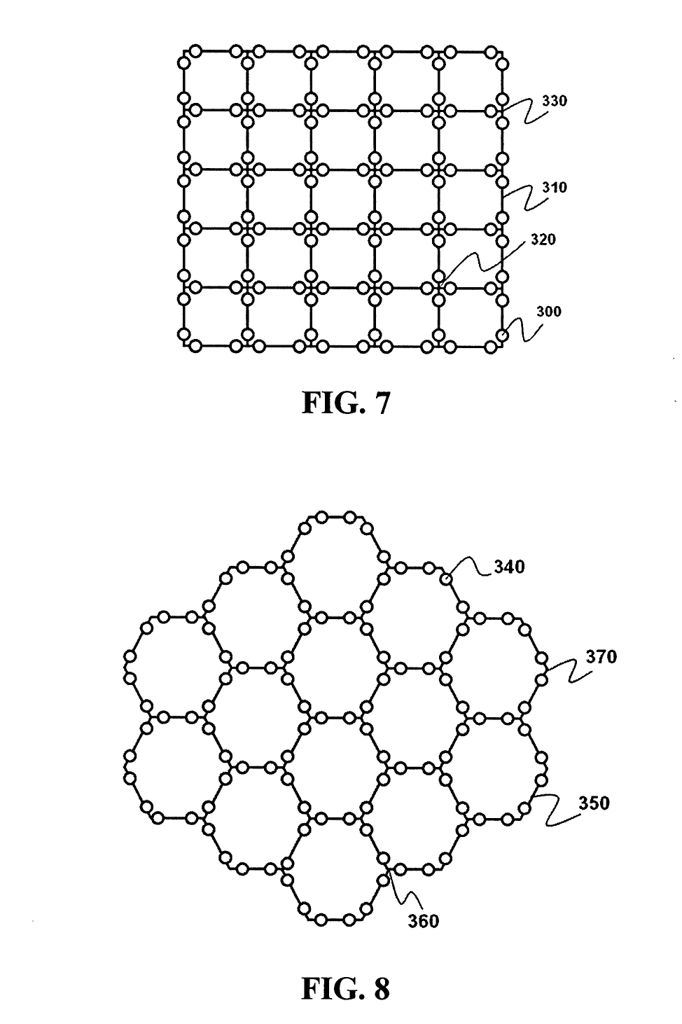

Another innovative compositions of the spherical sensing joints and the telescopic sticks is to assemble them in different grids or patterns as shown in FIGS. 7 and 8 which illustrate two diagrammatic arrangement for these compositions. Such compositions enable us to obtain a surface motion tracking system that detects the change of a surface shape, where this surface could be part of a human or animal body—resulting in the possibility to record and simulate the exact shape change of the human body or animal body in different times or circumstances for medical or healthcare purposes.

FIG. 7 illustrates connecting the rotating balls 300 and the telescopic sticks 310 using a cross-connection 320 to gather 4 spherical sensing joints, or using a T-connection 330 to gather 3 spherical sensing joints. FIG. 8 illustrates connecting the rotating balls 340, and the telescopic sticks 350 using a Y-connection 360 to gather 3 spherical sensing joints, or using an L-connection 370 to gather 2 spherical sensing joints.

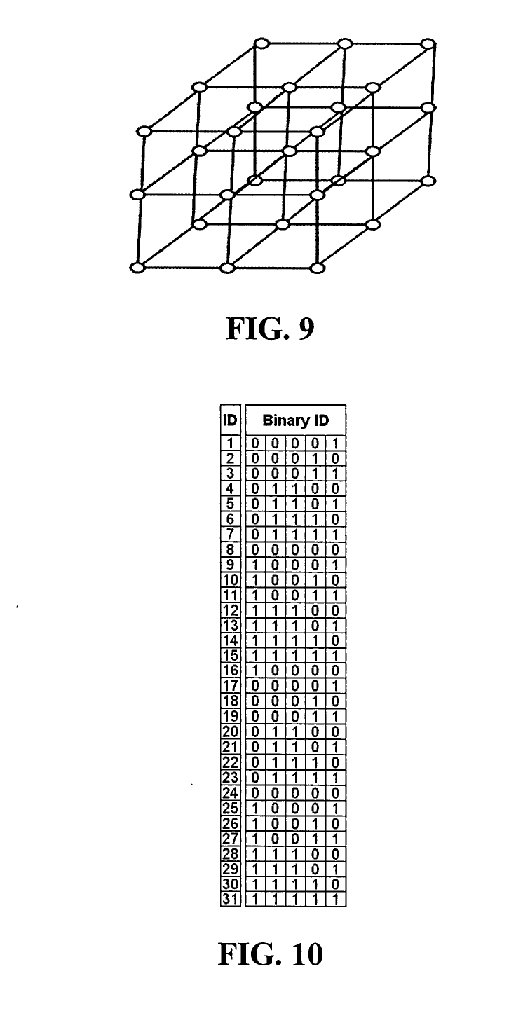

It is also possible to assemble the spherical sensing joints and the telescopic sticks to form a 3D grid of pattern. FIG. 9 illustrates a diagrammatic arrangement for such a 3D grid, where this assembly enables us to obtain a mass motion tracking system that is able to detect the partial motion of a mass under different circumstance that leas to a change in its 3D shape or volume.

The previous examples described the use of the present invention to detect and simulate the motion or change in shape of different objects including the objects' outlines, surfaces, or masses, whether these objects are living creatures or inanimate objects. However, it is believed that many software and hardware companies would come up with innumerable additional uses of the present invention once it became commercially available.

Overall the present invention utilizes an inexpensive and simple technology that makes the present motion tracking apparatus affordable for the users of the previous mentioned applications as will be described subsequently.

The spherical dotted sensor of FIG. 1 is a thin sheet that includes a plurality of dots that are spread evenly on one side of the sheet while the other side of this sheet is attached to the inner surface of the socket. Each dot functions as a key or button that provides “ON-OFF” signal, where the “ON” signal is provided when the sensing point 140 is in touch with the dot, and the “OFF” signal is provided when the sensing point 140 is not in touch with the dot. Each dot has an ID number and identified position in three dimensions relative to the center of the rotating ball 110; accordingly each dot's positions can be represented by the two components θ and φ of the spherical coordinate system.

The ID numbers of the dots start from 1 to n, where n is the total number of all dots of the same spherical dotted sensor. When a dot provides an “ON” signal while the sensing point 140 is touching it, the dot's ID and also its position in 3D are then identified. At this moment of contact the position of the touched dot is the same position of the sensing point, accordingly; the sensing point's position in 3D is then identified. The change of the sensing point's positions in 3D indicates the rotation of the rotating ball 110.

As mentioned previously, each dot functions as a key or button that provides an “ON” signal when the sensing point touches it. The sensing point is made of a conductive material that connects between two points of the dot to enable a small voltage to pass though the dot at the moment of contact. One of these two points is connected to the voltage source while the other point is connected to a microprocessor.

Each dot has a unique ID, accordingly for example when using a spherical dotted sensor that has 31 dots, each dot will have a unique ID from 1 to 31 as illustrated in the table of FIG. 10, where each ID can be represented using a binary numeral system consisting of 5 digits as shown in the table.

The microprocessor receives the successive signals of the dots that contact the sensing point and provides an immediate input to the computer system representing the successive ID's of these dots which represent the different positions of the sensing point or the rotation of the rotating ball. As long as the microprocessor is providing the same output for a period of time that means the rotating ball is still in the same position without rotation for the same period of time.

The dots are spread evenly on the thin sheet of the spherical dotted sensor where the distance between any two successive dots is constant and greater than the dimension of any side of the sensing point. This is to grantee that the sensing point will always touch one dot only after each rotation and accordingly one signal at a time will be provided to the microprocessor.

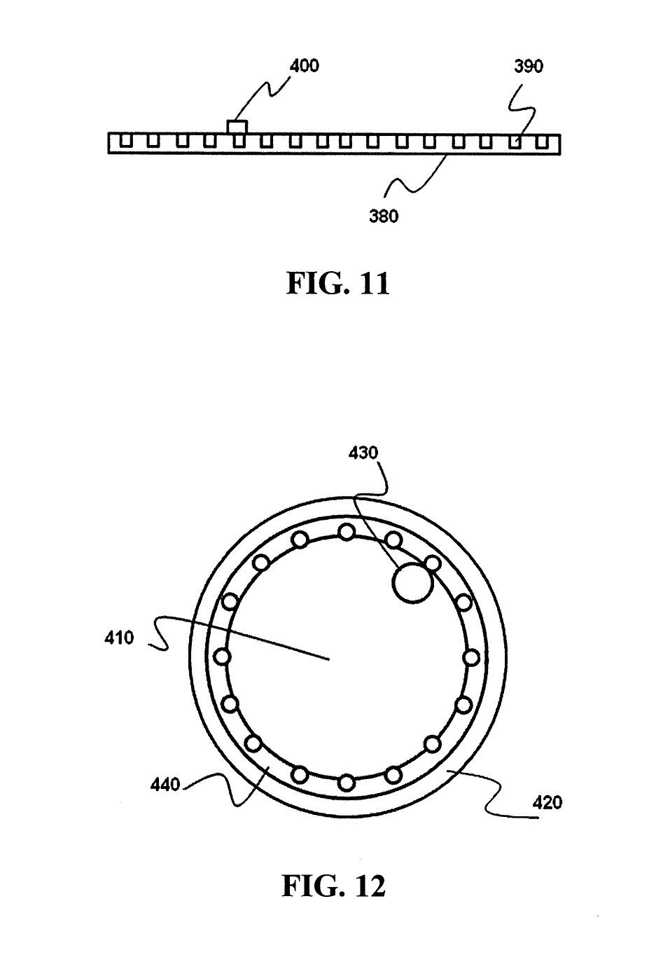

The sensing joints can take many other shapes than the spherical shape, for example FIG. 11 illustrates a linear sensing joint that is comprised of a linear dotted sensor 380 which is a thin linear sheet containing a plurality of dots 390 spread evenly on one side of the sheet where the other side is attached to a fixed surface. In this case the sensing point 400 is a small spot attached to the outer surface of the object that its movement needed to be detected, where the forward or backward movement of the object makes the sensing point contact different dots with each different movement.

The dots of the linear sensing join are similar to the dots of the spherical sensing joint except the position of each dot of the linear sensing joint is identified relative to a fixed point that could be the position of the first or last dot on the thin sheet. However, the linear sensing joints detect the linear movement of the objects, such as the linear movement of the interconnected cylindrical members of the telescopic sticks when they slide inside each others. In this case each interconnected cylindrical member will contain one linear dotted sensor attached to its inner surface and one sensing point attached to its outer surface.

FIG. 12 illustrates another shape of the sensing joints which is the circular sensing joint that detects the 2D rotation of an object. The circular sensing joint is comprised of a rotating circle 410 which is a circular surface that rotates about its center with the object's rotation, a ring 420 that serves as a container to house the rotating circle, a sensing point 430 which is a small spot on the perimeter of the rotating circle, and a circular dotted sensor 440 which is a thin sheet containing a plurality of dots spread evenly on one side of the thin sheet while the other side is attached to the inner surface of the ring.

The dots of the circular sensing joint are similar to the dots of the spherical sensing joint except the position of each dot of the circular sensing joint is identified relative to a fixed point which is the center of the rotating circle.

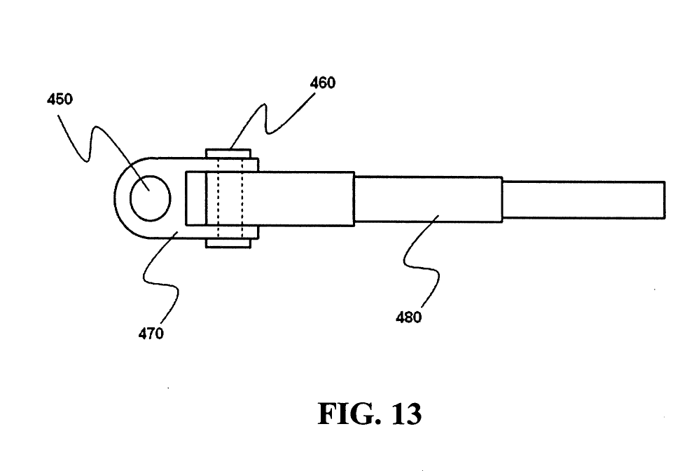

Two of said circular sensing joints can replace the functionality of one spherical sensing joint, where positioning one circular sensing joint perpendicular to the other can detect the rotation of a spherical joint in 3D. For example, FIG. 13 illustrates a first circular sensing joint 450 is placed in a horizontal position, a second circular sensing joint 460 is placed in a vertical position, a U-shape connection 470 that connects between the first and second circular sensing joints, and telescopic sticks 480 is connected to the second circular joint.

In this case rotating the telescopic sticks horizontally will horizontally rotate the rotating circle of the first circular sensing joint, and rotating the telescopic sticks vertically will vertically rotate the rotating circle of the second circular sensing joint. While rotating the telescopic sticks in other directions than the horizontal or vertical rotations will rotate in the same time both of the rotating circles of the first circular sensing joints and the second circular sensing joints horizontally and vertically respectively.

Generally; the previous described sensing joints detect the 2D rotation, the 3D rotation, and the linear movement of an object; however, it is possible to make these sensing joints detect the direction of pushing in 2D or 3D. For example, in FIG. 1 if the rotating ball 110 is pushed in a specific direction by moving the stick 130 in this specific direction while the socket 120 position is fixed, then a particular dot will be pressed by the rotating ball, where the position of this pressed dot relative to the center of the rotating ball before its movement represents the specific direction of pushing the rotating ball or the stick.

In this case the shape of the rotating ball and the socket of the spherical sensing joint can be in other shapes than the sphere or the semi-sphere, for example they can be in a shape of cube where the cubic shape enables detecting the pushing direction in the x, y, or z-axis of the Cartesian coordinate system. Also the cylinder shape can be used to enable detecting the pushing direction parallel or perpendicular to the axial center of the cylinder.

Also in FIG. 12 if the rotating circle 410 is pushed in a specific direction parallel to its plane then a specific dot will be pressed by the rotating circle, where the position of this pressed dot relative to the center of the rotating circle before its movement represents the specific direction of pushing the rotating circle.

In such cases there is no need for the sensing point since the rotating ball of the spherical sensing joint or the rotating circle of the circular sensing joint will press on the dot which will function as a regular key that generates “ON” signal when it is pressed.

Using a hand finger instead of the stick to push the rotating ball of the spherical sensing joint can make the spherical sensing joint be utilized as a computer input device that detects the 3D movement of the user's finger. Also using a hand finger to push the rotating circle of the circular sensing joint can make the circular sensing joint be utilized as a computer input device that detect the 2D movement of the user's finger.

Overall it is possible to make the output of the microprocessor of the different sensing joints connected directly to a computer or connected to a memory chip for saving the data until being transferred later to a computer. The main advantage of using the memory chip is to facilitate using the present invention in different environments away from the computer.

1. A motion tracking apparatus that is able to detect the rotation of an object's joints where said motion tracking apparatus is comprised of;
a) a plurality of sensing joints, each one detects the rotation of one of said joints, where said sensing joints is comprised of;
i) a rotating object that rotates according to the rotation of said joint.
ii) a chassis that serves as a container that houses said rotating object.
iii) a sensing point which is a small spot on the outer surface of said rotating object.
v) a dotted sensor which is a thin sheet contains a plurality of dots which means keys spread evenly on one side of said thin sheet while the other side is attached to the inner surface of said chassis, where each dot provides an “ON” signal when said sensing point touches it.
b) a plurality of telescopic sticks where each one is attached from one end to said rotating object and the other end is attached to said chassis of another sensing joint, and said telescopic sticks are comprised of;
i) a plurality of interconnected cylindrical members that slide inside each other telescopically to change the total span of said telescopic sticks.
ii) a sensing point which is a small spot on the outer surface of each of said interconnected cylindrical members.
iii) a linear dotted sensor which is a thin linear sheet containing a plurality of dots which means keys spread evenly on one side of said thin linear sheet while the other side is attached to the inner surface of each one of said interconnected cylindrical members, where each dot provides an “ON” signal when said sensing point touches it.
c) a microprocessor that receives the “ON” signals of the dots of said dotted sensors and said linear dotted sensors and interprets said “ON” signals into data representing the rotation of said rotating object, and the movement of said telescopic sticks.

2. The motion tracking apparatus of claim 1 wherein said rotating object is a sphere which means a ball, and said chassis is a socket which means a semi-sphere, where said motion tracking apparatus detects the rotation of a spherical joint(s) in three-dimensions.

3. The motion tracking apparatus of claim 1 wherein said rotating object is a circular surface, and said chassis is a ring, where said motion tracking apparatus detects the rotation of a joint/s in two dimension.

4. The motion tracking apparatus of claim 1 wherein said rotating object is a linear surface, and said chassis is a linear surface, where said motion tracking apparatus detects the forward and backward linear movement of an object.

5. The motion tracking apparatus of claim 1 wherein said rotating object is a semi-sphere and said chassis is a semi-sphere, where said motion tracking apparatus detects the pushing direction of said rotating object perpendicular to the inner surface of said chassis.

6. The motion tracking apparatus of claim 1 wherein said rotating object is a cylinder, and said chassis is a cylinder, where said motion tracking apparatus detects the pushing direction of said rotating object perpendicular to the inner surface of said chassis.

7. The motion tracking apparatus of claim 1 wherein said rotating object is a cube, and said chassis is a cube, where said motion tracking apparatus detects the pushing direction of said rotating object perpendicular to the inner surface of said chassis.

8. The motion tracking apparatus of claim 1 where said sensing joints and said telescopic sticks are attached to each other to simulate the composition of the human's body joints to detect the rotations of the human's body joints.

9. The motion tracking apparatus of claim 1 where said sensing joints and said telescopic sticks are attached to each other to simulate the composition of the human's hand joints to detect the rotations of the human's hand joints.

10. The motion tracking apparatus of claim 1 wherein said sensing joints and said telescopic sticks are attached to each other to form a linear composition to detect the linear forward and backward movement of an object.

11. The motion tracking apparatus of claim 1 wherein said sensing joints and said telescopic sticks are attached to each other to form a composition of a 2D grid to detect a surface movement of an object.

12. The motion tracking apparatus of claim 1 wherein said sensing joints and said telescopic sticks are attached to each others to form a composition of a 3D grid to detect a partial mass movement of an object.

13. The motion tracking apparatus of claim 1 further said microprocessor is connected to a computer system to provide immediate input of said data to the computer system.

14. The motion tracking apparatus of claim 1 further said microprocessor is connected to a memory chip that saves said data.

15. The motion tracking apparatus of claim 1 further a double-faced tape is used to attach said chassis to the tracked object's joints.

16. The motion tracking apparatus of claim 1 wherein said telescopic sticks are one stick that does not change its total span.

17. The motion tracking apparatus of claim 1 wherein said sensing point is made of a conductive material that when it touches one dot of said dotted sensor, a small voltage passes through said dot to provide an “ON” signal.

18. The motion tracking apparatus of claim 3 wherein two of said motion tracking apparatus are positioned perpendicularly to each others to detect the rotation of a spherical joint in three dimensions.

19. The motion tracking apparatus of claim 5 wherein said sensing point doesn't exist and said dot functions as a key that provides “ON’ signal when said rotating object is pushed to touch it.

20. The motion tracking apparatus of claim 5 further said rotating object is pushed by a user's finger.

21. The motion tracking apparatus of claim 6 wherein said sensing point doesn't exist and said dot functions as a key that provides “ON’ signal when said rotating object is pushed to touch it.

22. The motion tracking apparatus of claim 6 further said rotating object is pushed by a user's finger.

23. The motion tracking apparatus of claim 7 wherein said sensing point doesn't exist and said dot functions as a key that provides “ON’ signal when said rotating object is pushed to touch it.

24. The motion tracking apparatus of claim 7 further said rotating object is pushed by a user's finger.
